(19) United States
(12) Patent Application Publication
(10) Pub. No.: US 2017/0336337 A1
(43) Pub. Date: Nov. 23, 2017

(54) METHOD AND APPARATUS FOR MONITORING A HETEROGENEOUS MIXTURE

(71) Applicant: TTY-säätiö, Tampere (FI)

(72) Inventors: Teemu YLI-HALLILA, Tampere (FI); Matti JÄRVELÄINEN, Tampere (FI); Timo SALPAVAARA, Tampere (FI); Jarmo VERHO, Tampere (FI); Erkki LEVÄNEN, Tampere (FI); Matti VILKKO, Tampere (FI)

(21) Appl. No.: 15/157,519

(22) Filed: May 18, 2016

(51) Int. Cl. G01N 27/02

(52) U.S. Cl. CPC G01N 27/02

(57) ABSTRACT

A method for monitoring at least one property of a heterogeneous mixture includes coupling an oscillating radio frequency electric field to the heterogeneous mixture by using at least one capacitive electrode, and determining at least one property of the heterogeneous mixture by monitoring an input impedance of a sensor module, which includes at least one capacitive electrode.

### FIELD

Some versions may relate to monitoring at least one property of a heterogeneous mixture. Some versions may relate to an apparatus for monitoring at least one property of a heterogeneous mixture.

### BACKGROUND

A ceramic component may be manufactured e.g. by coating a semi-manufactured component with a heterogeneous mixture, which comprises fine ceramic particles. The quality of the ceramic component may depend on the properties of the heterogeneous mixture.

The properties of the heterogeneous mixture may be measured e.g. by extracting a sample from a container, and analyzing the extracted sample in a laboratory. The sample may be analyzed e.g. by separating the particles from the sample by centrifugal separation and by determining the mass of the particles by weighing.

### SUMMARY

Some versions may relate to monitoring at least one property of a heterogeneous mixture. Some versions may relate to an apparatus, which is arranged to monitor at least one property of a heterogeneous mixture.

Some versions may relate to a sensor module. Some versions may relate to an apparatus for producing a heterogeneous mixture. Some versions may relate to a method for controlling operation of an apparatus, which is arranged to produce a heterogeneous mixture.

According to an aspect, there is provided a method for monitoring at least one property (X1) of a heterogeneous mixture (MX), the method comprising:
coupling an oscillating radio frequency electric field (S2) to the heterogeneous mixture (MX) by using at least one capacitive electrode (C1a), and
determining at least one property (X1) of the heterogeneous mixture (MX) by monitoring an input impedance (Z_{SEN}) of a sensor module (SEN1), which comprises said at least one capacitive electrode (C1a).

According to an aspect, there is provided an apparatus (500), comprising:
at least one capacitive electrode (C1a) to couple an oscillating radio frequency electric field (S2) to a heterogeneous mixture (MX),
a resonance circuit (CIR1), which comprises said at least one capacitive electrode (C1a), and
a data processing unit (CNT1) configured to determine at least one property (X1) of the heterogeneous mixture (MX) by monitoring an input impedance (Z_{SEN}) of the resonance circuit (CIR1).

According to an aspect, there is provided a method for producing a heterogeneous mixture (MX), the method comprising:
obtaining a heterogeneous mixture (MX), which comprises particles (P1) suspended in a liquid medium (LIQ1),
coupling an oscillating radio frequency electric field (S2) to the heterogeneous mixture (MX) by using at least one capacitive electrode (C1a),
determining at least one measured property (X1) of the heterogeneous mixture (MX) by monitoring an input impedance (Z_{SEN}) of a sensor module (SEN1), which comprises said at least one capacitive electrode (C1a), and
controlling the volume fraction of the particles (P1) based on the at least one measured property (X1).

The method may comprise using a resonance circuit, which comprises a sensor antenna. The resonance circuit may be an inductor-capacitor resonance circuit (LC resonance circuit). The sensor antenna may comprise e.g. at least one capacitive element such that the capacitive element may operate as a capacitive part of the resonance circuit. The at least one capacitive element may operate as a capacitive antenna element, which generates an oscillating electric field. The oscillating electric field generated by the sensor antenna may interact with the heterogeneous mixture so that the complex dielectric permittivity of the heterogeneous mixture may have an effect on the capacitance of the resonance circuit. A change in the permittivity of the heterogeneous mixture may cause a change of the equivalent capacitance of the resonance circuit. Consequently, a change of a property of the heterogeneous mixture may change the input impedance of the resonance circuit. The complex permittivity of the system may cause losses, which may be measured e.g. by varying the frequency of a driving signal coupled to the resonance circuit.

The complex impedance of the sensor module may have a real part and an imaginary part. The complex impedance may be a function of the frequency. The method may comprise measuring a complex impedance spectrum of the sensor module. The method may comprise determining e.g. a maximum of the real part of complex impedance. The method may comprise determining a resonance frequency associated with the maximum of the real part of complex impedance. The method may comprise determining phase of the impedance. The method may comprise determining a resonance frequency associated with the phase minimum. The method may subsequently comprise determining at least one property of the heterogeneous mixture from the measured complex impedance spectrum. In particular, the method may subsequently comprise determining at least one property of the heterogeneous mixture from the measured resonance frequency.

The method may comprise measuring a gain response of the sensor module as the function of frequency. The gain response may be represented as a curve. The place and form of the gain response curve may be characterized as one or more features. The gain response curve may exhibit e.g. a resonance dip in the vicinity of the resonance frequency of the resonance circuit. The method may comprise e.g. determining the spectral position (fₚ) of resonance dip and/or a spectral width (BWG) of the resonance dip. Determining one or more features may comprise e.g. fitting a polynomial regression model to a measured gain response data. The method may comprise linking a change of at least one measurand to a change of at least one feature of the gain response curve. A relation between measurands and extracted features may be analyzed e.g. by using principal component analysis.

The method may provide information about at least one property of a heterogeneous mixture. The method may provide said information substantially in real time. The method may provide data indicative of at least one property of a heterogeneous mixture at a high data acquisition rate. The method may be non-invasive. The information may be obtained also without extracting a sample from a manufacturing apparatus. The information may be used e.g. for controlling operation of a manufacturing apparatus.

The method may provide data indicative of complex permittivity of a heterogeneous mixture. The method may provide data indicative of concentration of particles in the heterogeneous mixture. The method may provide data indicative of volume fraction of particles in a heterogeneous mixture. The method may provide data indicative of mass fraction of particles in a heterogeneous mixture. The method may provide data indicative of concentration of water in the heterogeneous mixture. The method may provide data indicative of concentration of a dispersing agent in the heterogeneous mixture. The method may provide data indicative of effective particle size of a heterogeneous mixture. The method may provide data indicative of degree of crystallization in the heterogeneous mixture. The method may provide data indicative of spatial variation of particle density in the heterogeneous mixture.

### BRIEF DESCRIPTION OF THE DRAWINGS

In the following examples, several variations will be described in more detail with reference to the appended drawings, in which

FIG. 1 shows, by way of example, an apparatus for monitoring a heterogeneous mixture,

FIG. 2 shows, by way of example, current and voltage waveforms of the reader coil,

FIG. 3a shows, by way of example, a lumped element model of the measuring unit,

FIG. 3b shows, by way of example, a setup for monitoring the impedance of the resonance circuit,

FIG. 4a shows, by way of example, a resonance dip associated with a first state of a heterogeneous mixture,

FIG. 4b shows, by way of example, a resonance dip associated with a second different state of the heterogeneous mixture.

FIG. 5a shows, by way of example, spectral position and spectral width of resonance dip as a function of a first property of a heterogeneous mixture,

FIG. 5b shows, by way of example, spectral position and spectral width of resonance dip as a function of a second property of a heterogeneous mixture,

FIG. 5c shows, by way of example, evolution of spectral position and spectral width during preparation of a heterogeneous mixture,

FIG. 6a shows, by way of example, a sensor unit, which comprises a resonance circuit and a reader coil,

FIG. 6b shows, by way of example, a measurement probe immersed in a heterogeneous mixture,

FIG. 6c shows, by way of example, a sensor module positioned on the inner surface of a container,

FIG. 6d shows, by way of example, a cross sectional view of a sensor module,

FIG. 7a shows, by way of example, the phase difference between current and voltage of the reader coil as the function of frequency,

FIG. 7b shows, by way of example, evolution of spectral position and phase difference during preparation of a heterogeneous mixture, and

FIG. 8 shows, by way of example, an apparatus for producing a heterogeneous mixture.

### DETAILED DESCRIPTION

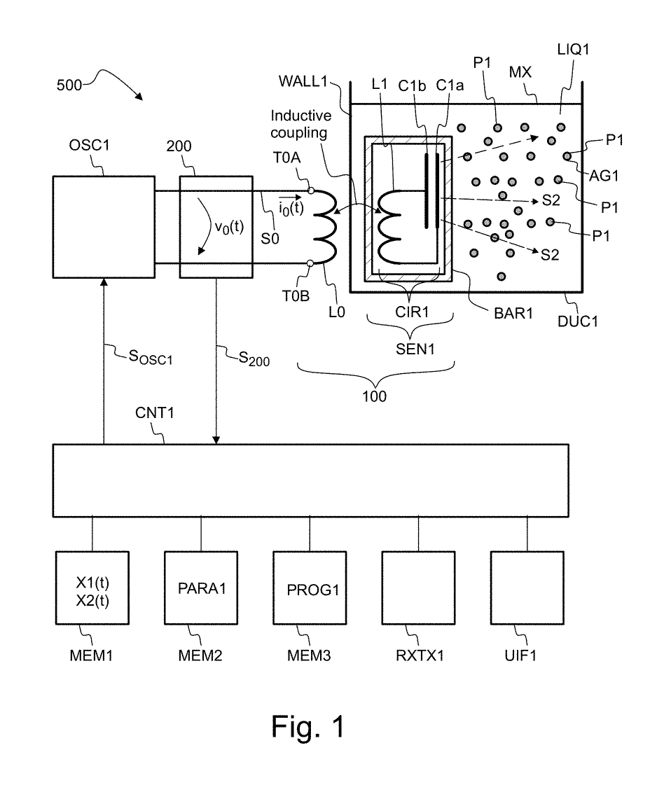

Referring to FIG. 1, a measuring apparatus 500 may be arranged to monitor at least one property X1 of a heterogeneous mixture MX. The measuring apparatus 500 may comprise a sensor unit 100, a signal generator OSC1, an impedance monitoring unit 200, and a data processing unit CNT.

The heterogeneous mixture MX may be confined e.g. in a container or duct DUC1. The heterogeneous mixture LIQ may contain a plurality of particles P1. The heterogeneous mixture MX may contain a plurality of particles P1 suspended in a fluid LIQ1. In particular, the fluid LIQ1 may be a liquid. The heterogeneous mixture MX may contain a plurality of particles P1 suspended in a liquid medium LIQ1.

The sensor unit 100 may comprise a sensor module SEN1 and a reader coil L0. The reader coil L0 may be arranged to couple operating energy to the sensor module SEN1 and to read information from the sensor module SEN1. The sensor module SEN1 may comprise at least one capacitive electrode C1a, which may be arranged to couple an oscillating radio frequency electric field S2 to the heterogeneous mixture MX. The dielectric permittivity of the heterogeneous mixture MX may have an effect on the input impedance Z_{SEN} of the sensor module SEN1. Consequently, at least one property X1 of the heterogeneous mixture MX may be determined by monitoring the input impedance Z_{SEN} of the sensor module SEN1. The impedance Z_{SEN} may, in turn, be monitored by monitoring the impedance of the reader coil L0 when the reader coil L0 is inductively coupled to the sensor module SEN1.

The method may comprise:
coupling an oscillating radio frequency electric field S2 to the heterogeneous mixture MX by using at least one capacitive electrode C1a, and
determining at least one property X1 of the heterogeneous mixture MX by monitoring an input impedance Z_{SEN} of the sensor module SEN1, which comprises said at least one capacitive electrode C1a.

The sensor module SEN1 may comprise a resonator circuit CIR1. The sensor module SEN1 may comprise at least one capacitive electrode C1a, which may be arranged to couple a radio frequency electric field S2 to the heterogeneous mixture MX. The electric field S2 emitted from the capacitive electrode C1a may interact with the heterogeneous mixture MX such that the complex permittivity of the heterogeneous mixture MX may have an effect on the resonating frequency and/or on the Q-factor of the resonator circuit CIR1.

The capacitive electrode C1a may be a capacitive element, which may form a capacitor C1 together with a second capacitive element C1b. The second capacitive element C1b may also operate as an capacitive electrode. The resonator circuit CIR1 may be an inductor-capacitor (LC) resonance circuit. The capacitive electrode C1a may operate as a capacitive component of the resonance circuit CIR1. The capacitive electrode C1a may be arranged to operate as a part of the resonance circuit CIR1 such that a resonance frequency fₚ of the resonance circuit CIR1 depends on the impedance of the capacitor C1, which comprises the capacitive electrode C1a. The sensor module SEN1 may comprise a resonance circuit CIR1, the resonance circuit CIR1 may be an inductor capacitor resonance circuit, the capacitive electrode C1a may be a capacitive element, and the capacitive electrode C1a may operate as a capacitive component of the resonance circuit CIR1.

The resonator circuit CIR1 may comprise a first inductor L1. The first inductor L1 may operate as an inductive component of the resonance circuit CIR1. The first inductor L1 may be connected in parallel with the capacitor C1 and/or in series with the capacitor C1.

The sensor unit 100 may comprise a second inductor L0. The second inductor may also be called e.g. as a reader coil. The first inductor L1 may be inductively coupled to the second inductor L0. The inductor L0 may form an inductive link together with the inductor L1. The second inductor L0 may inductively transfer operating energy to the resonator circuit CIR1. The resonator circuit CIR1 may be caused to oscillate by applying a driving signal S0 to the second inductor L0. The method may comprise applying the driving signal S0 to the second inductor L0 so as to cause oscillation of the resonance circuit CIR1. The method may comprise monitoring the input impedance Z₁₀₀ of the sensor device 100 which comprises the second inductor L0 and the resonance circuit CIR1. The input impedance Z₁₀₀ of the sensor device 100 may mean the complex ratio of the voltage v₀(t) to the current i₀(t) in a situation where the resonator circuit CIR1 is inductively coupled to the reader coil L0.

The second inductor L0 may be galvanically separate from the first inductor L0 e.g. in order to reduce signal noise. The inductor L0 may inductively couple operating power to the inductor L1 of the resonance circuit CIR1. This arrangement may allow simple and rugged construction. This arrangement may allow a short range wireless measurement. This arrangement may allow measurement e.g. through a pressurized dielectric wall of the duct or container DUC1. The material of the duct or container DUC1 may be e.g. plastic, glass or reinforced composite.

The inductor L0 may be a reader coil, and the inductor L1 may be a sensor coil. The distance between the reader coil L0 and the inductor coil L1 may be e.g. in the range of 0.01 to 3 times the diameter of the sensor coil L1. The distance between the reader coil L0 and the inductor coil L1 may be e.g. in the range of 0.1 to 2 times the diameter of the sensor coil L1.

The inductor L0 may also be galvanically connected to the first inductor L1 and/or a part of the inductor L1 may operate as the second inductor L0. The driving signal S0 may be coupled to the resonance circuit CIR1 also without using the inductor L0. For example, the driving signal S0 may be coupled to the resonance circuit CIR1 e.g. via a capacitor or via a resistor. The driving signal S0 may be directly coupled to the resonance circuit CIR1.

The signal generator OSC1 may generate a driving signal S0, which may be coupled to the sensor module SEN1 by using the reader coil L0. The driving signal S0 may have an instantaneous voltage v₀(t) and an instantaneous current i₀(t). The frequency of the driving signal S0 may be e.g. in the range of 100 kHz to 1 GHz, preferably in the range of 10 MHz to 100 MHz. The frequency of the electric field S2 may be e.g. in the range of 100 kHz to 1 GHz, preferably in the range of 10 MHz to 100 MHz.

The complex dielectric permittivity of the heterogeneous mixture MX may have a real part and an imaginary part. The sensor unit 100 may transfer energy from the signal generator OSC1 to the heterogeneous mixture MX, depending on the imaginary part of the dielectric permittivity of the heterogeneous mixture MX. The combination of the sensor unit 100 and the heterogeneous mixture MX may absorb energy from the signal generator OSC1. The combination may absorb more energy when the frequency of the driving signal S0 is equal to the resonance frequency fₚ of the resonance circuit CIR1, and the combination may absorb less energy when the frequency of the driving signal S0 is equal to the resonance frequency fₚ of the resonance circuit CIR1. The transfer of energy from the reader coil L0 to the resonance circuit CIR1 may be more efficient when the frequency of the driving signal S0 is equal to the resonance frequency fₚ of the resonance circuit CIR1, and the transfer of energy may be less efficient when the frequency of the driving signal S0 is different from the resonance frequency fₚ of the resonance circuit CIR1. The sensor unit 100 may also be understood to reflect energy back to the signal generator OSC1 so that the reflection coefficient has a minimum at the resonance frequency fₚ.

The apparatus 500 may comprise an impedance monitoring unit 200, which may be arranged to monitor the impedance of the resonance circuit CIR1. The impedance monitoring unit 200 may be arranged to monitor the impedance of a system, which comprises the second inductor L0, the resonator circuit CIR1, the capacitive electrode C1a, and the heterogeneous mixture MX.

The impedance monitoring unit 200 may monitor the impedance e.g. by monitoring the current i₀(t) and/or voltage v₀(t) of the driving signal S0. The impedance monitoring unit 200 may monitor the impedance e.g. by comparing the magnitude of the current i₀(t) with the magnitude of the voltage v₀(t). The impedance monitoring unit 200 may monitor the impedance e.g. by monitoring the phase difference Δφ between the current i₀(t) and voltage v₀(t). The impedance monitoring unit 200 may monitor the impedance e.g. by comparing the magnitude and phase of the current i₀(t) with the magnitude and phase of the voltage v₀(t). The impedance monitoring unit 200 may monitor the impedance e.g. by detecting a change of the current i₀(t) and/or voltage v₀(t).

The sensor unit 100 may comprise a dielectric layer BAR1 to electrically insulate the capacitive electrode C1a from the heterogeneous mixture MX. The layer BAR1 may also be called e.g. as a barrier layer. The dielectric layer BAR1 may provide a minimum distance between the capacitive electrode C1a and the heterogeneous mixture MX. The heterogeneous mixture MX may disturb or prevent operation of the resonance circuit CIR1 if the distance between the capacitive electrode C1a and the heterogeneous mixture MX is too small. The minimum distance between the capacitive electrode C1a and the heterogeneous mixture MX may be e.g. greater than or equal to 0.1 mm. The minimum distance may be e.g. in the range of 0.2 to 5 mm. The dielectric layer BAR1 may cover or surround at least the capacitive elements C1a, C1b of the resonance circuit CIR1. The dielectric layer BAR1 may cover or surround the electrically conductive components of the resonance circuit CIR1. The dielectric layer BAR1 may comprise or consist essentially of e.g. plastic, resin, glass, or ceramic material. Absorption of a material from the heterogeneous mixture MX into the dielectric layer BAR1 may cause an error in the measurement result. The material of the dielectric layer BAR1 may be selected so as to reduce absorption of the liquid medium LIQ1 of the heterogeneous mixture MX into the dielectric layer BAR1. The porosity of the dielectric layer BAR1 may be lower than 1%, lower than 0.1% or even lower than 0.01%. Water absorption of the layer BAR1 may be lower than 1%, lower than 0.1% or even lower than 0.01% by weight during a time period of 1000 hours at the temperature of 25° C. and at the constant absolute pressure of 100 kPa.

The sensor module SEN1 may comprise the resonance circuit CIR1, the capacitive electrode C1a, and the dielectric layer BAR1.

The sensor unit 100 may comprise the sensor module SEN1 and optionally also the reader coil L0. The sensor unit 100 may also be called e.g. as a measuring device 100 or as a measuring head.

The sensor module SEN1 or the sensor unit 100 may be immersed in the heterogeneous mixture MX.

The sensor module SEN1 may also have e.g. a planar form such that the sensor module SEN1 may be attached to the inner or outer surface of a duct or container. The sensor module SEN1 may be attached to a surface e.g. by an adhesive, by mechanical fixing means (e.g. by one or more screws or clamps), or by gravity. Positioning the sensor module SEN1 outside the duct or container may provide a rugged and stable set-up. Positioning the sensor module SEN1 outside the duct or container may be used e.g. when the mixture MX may cause corrosion and/or abrasion.

A duct or container DUC1 may have a wall WALL1. The wall WALL1 may comprise electrically insulating material such that energy may be inductively coupled through the wall WALL1. The sensor unit 100 may be implemented in a distributed manner such that the reader coil L0 is positioned on an outer side of the wall WALL1, and the resonance circuit CIR1 is positioned on an inner side of the wall WALL1. Thus, it is not necessary to provide an opening in the wall WALL1 in order to immerse capacitive electrode C1a in the heterogeneous mixture MX. This set-up may facilitate measurements e.g. in a pressurized duct or container DUC1. Positioning the sensor module SEN1 inside the duct or container may facilitate detecting small changes in the at least one property X1, X2.

The resonance circuit CIR1 may be a passive circuit. The resonance circuit CIR1 may be implemented such that it does not comprise a power source galvanically connected to the resonance circuit CIR1. The operating power may be inductively coupled to the resonance circuit CIR1 via the coils L0, L1.

The apparatus 500 may comprise a signal generator OSC1. The signal generator OSC1 may be arranged to provide an oscillating driving signal S0 to the reader coil L0 or to the resonance circuit CIR1. The method may comprise varying the frequency f of a driving signal S0 coupled to the resonance circuit CIR1. The signal generator OSC1 may be arranged to vary the frequency of the driving signal S0. The signal generator OSC1 may be arranged to sweep the frequency of the driving signal S0. The frequency of the driving signal S0 may be e.g. in the range of 100 kHz to 1 GHz, preferably in the range of 10 MHz to 100 MHz. The method may comprise sweeping the frequency of the signal S0 e.g. in a range, which is between f_{MIN} and f_{MAX}, wherein the maximum frequency f_{MAX} may be e.g. 150% of the minimum frequency f_{MIN}. The number of sweeps per second may be e.g. higher than 1/s, higher than 10/s, higher than 100/s, or even higher than 1000 sweeps/second. In an embodiment, the driving signal S0 may also be pseudorandom binary sequence. The control unit CNT1 may optionally control the operation and/or frequency of the signal generator OSC1 e.g. by sending a control signal S_{OSC1} to the signal generator OSC1. The apparatus 500 may comprise an impedance monitoring unit 200. The impedance monitoring unit 200 may be arrange to provide a monitoring signal S₂₀₀ indicative of the impedance of the resonance circuit CIR1. The impedance monitoring unit 200 may be arrange to provide a monitoring signal S₂₀₀ indicative of the impedance of the measurement head 100. The impedance monitoring unit 200 may be arrange to provide a monitoring signal S₂₀₀ e.g. by monitoring the monitoring the current i₀(t) and voltage v₀(t) of the driving signal S0 coupled to the resonance circuit CIR1.

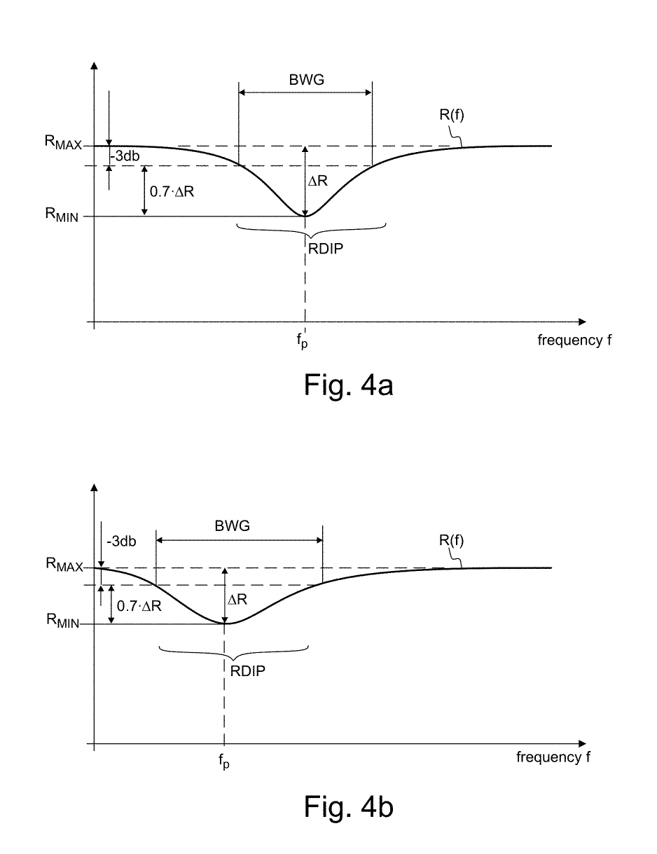

The monitoring signal S₂₀₀ may be e.g. substantially equal to the voltage over the reader coil L0 when an oscillator voltage V_{OSC}(t) is coupled to the reader coil L0 through an auxiliary impedance (e.g. a resistor) Z₂₀₀ (See FIG. 3b).

The monitoring signal S₂₀₀ may also be e.g. substantially proportional to the electric current through the reader coil L0. The monitoring signal S₂₀₀ may also be e.g. substantially proportional to the voltage difference over the auxiliary impedance (resistor) Z₂₀₀.

The apparatus 500 may comprise a control unit CNT1 for controlling operation of the apparatus 500 and/or for processing data. The apparatus 500 may optionally comprise a memory MEM1 for storing measured data and/or for storing values X1, X2 determined from the measured data. The apparatus 500 may optionally comprise a memory MEM2 for storing auxiliary parameters PARA1. The auxiliary parameters PARA1 may comprise e.g. calibration parameters and/or operating parameters for controlling the frequency of the signal generator OSC1. The apparatus 500 may optionally comprise a memory MEM3 for storing computer program code PROG1. The computer program code PROG1 may cause, when executed by the data processor CNT1, determining one or more parameters of the heterogeneous mixture MX by monitoring the impedance of a resonance circuit CIR1. The apparatus 500 may optionally comprise a user interface UIF1 e.g. for displaying measured data and/or for receiving user input from a user. The user interface UIF1 may comprise e.g. a touch screen, a display and/or one or more keys.

The apparatus 500 may optionally comprise a communication unit RXTX1. The communication unit RXTX1 may be arranged to transmit data and/or receive data. The communication unit RXTX1 may be arranged to communicate e.g. with a computer or with data server. The communication unit RXTX1 may be arranged to communicate with a control unit of an industrial process. The communication unit RXTX1 may be arranged to communicate e.g. via the Internet, via a mobile communications network, via a wireless local area network, via an electric cable, and/or via an optical cable. The communication unit RXTX1 may be arranged to communicate e.g. according to the Bluetooth standard.

The heterogeneous mixture MX comprises liquid or solid particles P1. The size of the particles P1 may be e.g. in the range of 100 nm to 100 μm. For example, at least 50% of the mass of the particles P1 may be e.g. in the size range of 0.1 μm to 3 μm. The heterogeneous mixture MX may be a colloidal suspension.

The volume fraction of gas or gases in the heterogeneous mixture MX may be e.g. smaller than 1%, or even smaller than 0.1% e.g. in order to provide a more accurate measurement result. High volume fraction of gas may cause random fluctuations, which in turn may disturb measurement of particle concentration.

The heterogeneous mixture MX may optionally comprise one or more additives, e.g. a dispersing agent. The heterogeneous mixture MX may optionally comprise one or more additives AG1. The heterogeneous mixture MX may optionally comprise e.g. a dispersing agent AG1. The dispersing agent AG1 may e.g. form a layer on the particles P1. The particles may be coated with the dispersing agent AG1.

The duct or container DUC1 does not need to be a part of the apparatus 500.

The apparatus 500 may also be arranged to process data in a distributed manner. The data processor CNT1 may be remote from the sensor module SEN1. Measured data S₂₀₀ may be transmitted e.g. to a remote computer CNT1, and one or more property values X1, X2 may be determined from the data S₂₀₀ at the location of the remote computer. Measured data S₂₀₀ may be transmitted to the remote data processing unit CNT1 e.g. via the Internet.

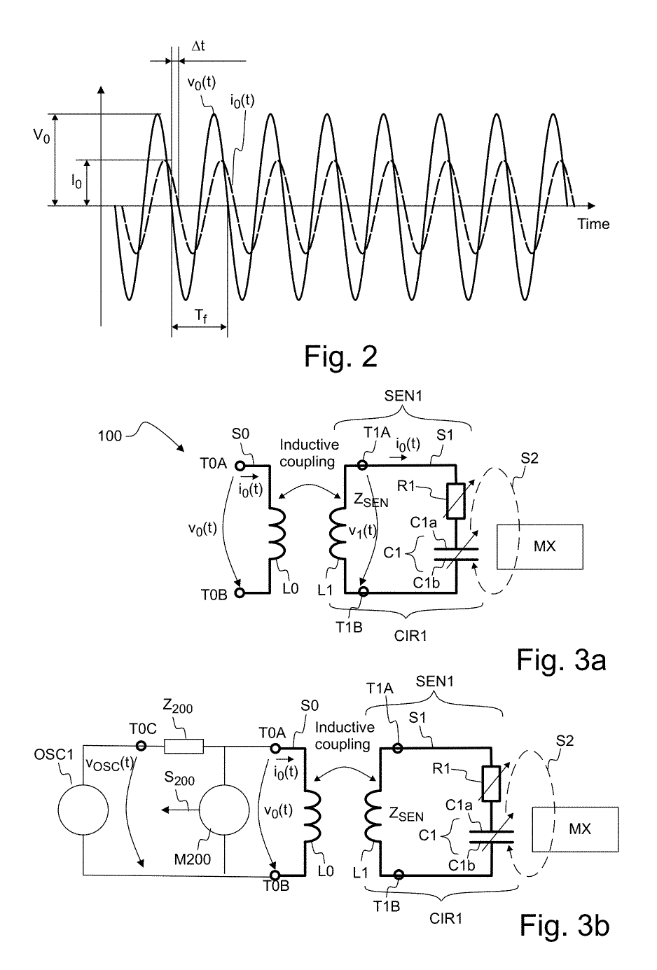

FIG. 2 shows, by way of example, the waveforms of the current i₀(t) and voltage v₀(t) of the driving signal S0. The voltage may have amplitude V₀. The current may have amplitude I₀. T_{f} denotes the period of the voltage v₀(t). The frequency f of the voltage v₀(t) is equal to 1/T_{f}. Δt denotes the time delay between the zero crossing points of the voltage v₀(t) and current i₀(t). The phase difference Δφ between the voltage v₀(t) and the current i₀(t) is proportional to Δt/T_{f}.

FIG. 3a shows, by way of example, a simplified lumped element model of the measurement head 100. The resonance circuit CIR1 may be an inductor-capacitor circuit (LC circuit). The resonance circuit CIR1 may comprise a capacitor C1 and the first inductor L1. The capacitor C1 may be connected in series or in parallel with the inductor L1.

The capacitive electrode C1a may be a capacitive element, which forms the capacitor C1 with a second capacitive element C1b. The capacitive electrode C1a may couple an oscillating electric field S2 to the heterogeneous mixture MX. The complex permittivity of the heterogeneous mixture MX may have an effect on the capacitance value of the capacitor C1 and/or on an effective resistance R1 of the resonance circuit CIR1. A change of the real part of the permittivity of the heterogeneous mixture MX may change the capacitance value of the capacitor C1. A change of the imaginary part of the permittivity of the heterogeneous mixture MX may change the resistance R1 of the resonance circuit CIR1.

The oscillating driving signal S0 may be coupled to input nodes T0A, T0B of the reader coil L0. The driving signal S0 may be inductively coupled from the reader coil L0 to the sensor coil L1. The driving signal S0 may induce an oscillating sensor signal S1 in the resonance circuit CIR1. The sensor signal S1 may have an oscillating current and voltage. The frequency of the sensor signal S1 and the frequency of the electric field S2 may be equal to the frequency of the driving signal S0.

The sensor module SEN1 may be sensitive to changes, which take place in a sample volume of the heterogeneous mixture MX in the vicinity of the one or more capacitive electrodes C1a, C1b. The dimensions of the sample volume may depend e.g. on the width of the capacitive electrode C1a and on the distance between the electrodes C1a, C1b. The width of the capacitive electrode C1a may be e.g. in the range of 1 mm to 100 mm. The width of the capacitive electrode C1a may be e.g. in the range of 5 mm to 20 mm. The distance between the electrodes C1a, C1b. may be e.g. in the range of 10 μm to 10000 μm. The distance between the electrodes C1a, C1b. may be e.g. in the range of 50 μm to 500 μm. The distance between the electrodes C1a, C1b. may be e.g. in the range of 1 mm to 10mm in order to provide a long detection range. The surface area of one side the element C1a may be e.g. in the range of 1 mm² to 10⁵ mm². In particular, the surface area of one side the element C1a may be e.g. in the range of 10 mm² to 10³ mm². The shape of the element C1a may be e.g. rectangular, elliptical or circular.

The reader coil L0, the resonance circuit CIR1, and the sample volume of the heterogeneous mixture MX may together form a combination. The term coupled reader coil L0 may refer to the reader coil L0 which is coupled to the resonance circuit CIR1 via the sensor coil L1. The impedance of the coupled reader coil may depend on the input impedance Z_{SEN} of the sensor module SEN1. The term decoupled reader coil L0 may refer to the reader coil L0 which is not coupled to the resonance circuit CIR1. The complex impedance of the coupled reader coil L0 may depend on the complex impedance of the sample volume of the heterogeneous mixture MX. The complex impedance of the decoupled reader coil L0 does not depend on the complex impedance of the sample volume of the heterogeneous mixture MX. The complex impedance of the coupled reader coil L0 may be determined from the instantaneous current i₀(t) and/or voltage v₀(t) of the coupled reader coil L0. The method may comprise using the reader coil L1 to measure the behavior of the resonance circuit CIR1. The impedance of the mixture MX may be monitored by monitoring the response of the resonance circuit CIR1 to the driving signal S0 coupled to the reader coil L1. The use of the resonance circuit CIR1 may facilitate monitoring of the complex dielectric permittivity of the sample volume. The use of the resonance circuit CIR1 may facilitate detecting a change of the complex dielectric permittivity of the sample volume. The use of the resonance circuit CIR1 may e.g. improve signal to noise ratio of the measurement. The measurement apparatus 500 may be arranged to monitor the sample volume by monitoring the impedance of the coupled reader coil L0.

T1A may denote a first node of the inductor L1 (i.e. the sensor coil L1). T1B may denote the second node of the inductor L1. The sensor coil L1 may be connected between the nodes T1A, T1B. i₁(t) may denote the instantaneous current of the sensor coil L1. v₁(t) may denote the instantaneous voltage of the sensor coil L1. The input impedance Z_{SEN} of the sensor module SEN1 may mean the complex ratio of the voltage vi(t) to the current i₁(t).

The term coupled sensor coil L1 may refer to the sensor coil L1 which is operating as a part of the resonance circuit CIR1 and which is also (inductively) coupled to the reader coil L0. The measurement apparatus 500 may be arranged to monitor the sample volume by monitoring the impedance of the sensor coil L1. The measurement apparatus 500 may be arranged to monitor the sample volume by monitoring a change of the impedance of the sensor coil L1. The measurement apparatus 500 may be arranged to monitor the impedance of the coupled sensor coil L1 e.g. by monitoring the impedance of the coupled reader coil L0.

Referring to FIG. 3b, the oscillator signal v_{OSC}(t) obtained from the signal generator OSC1 may be coupled to the reader coil L0 e.g. via a reference impedance Z₂₀₀. The reference impedance Z₂₀₀ may be implemented e.g. by using a resistor, a capacitor and/or an inductor. In particular, the oscillator signal v_{OSC}(t) may be coupled to the reader coil L0 through a resistor. The ratio of the voltage v₀(t) of the driving signal S0 to the primary oscillator signal v_{OSC}(t) may be called e.g. as the gain response R(f). The voltage v₀(t) may have a phase difference with respect to the oscillator signal v_{OSC}(t). Vo may denote the amplitude of the oscillating voltage v₀(t), and V_{OSC} may denote the amplitude of the oscillating voltage v_{OSC}. The real part of the gain response R(f) may be proportional to the ratio V₀/V_{OSC}. The magnitude of the gain response R(f) may be proportional to the ratio V₀/V_{OSC}. The gain response R(f) may exhibit a dip in the vicinity of the resonance frequency fₚ of the circuit CIR1. The gain response may depend on the frequency f of the oscillator signal v_{OSC}(t). The oscillating frequency of the circuit CIR1 may be equal to the frequency f of the oscillator signal v_{OSC}(t). The inverse 1/R(f) of the gain response R(f) may exhibit a peak in the vicinity of the resonance frequency fₚ of the circuit CIR1.

The input impedance Z_{SEN} of the resonance circuit CIR1 may refer to the impedance of the coupled sensor coil L1. The impedance of the coupled reader coil L0 may be monitored e.g. by using a monitoring unit 200, which comprises a reference impedance Z₂₀₀ and a voltage meter M1. The impedance of the coupled sensor coil L1 may be monitored e.g. by using a monitoring unit 200, which comprises a reference impedance Z₂₀₀ and a voltage meter M1. The impedance of the resonance circuit CIR1 may be monitored e.g. by using a monitoring unit 200, which comprises a reference impedance Z₂₀₀ and a voltage meter M1. In particular, the reference impedance Z₂₀₀ may be implemented by using resistor.

The signal generator OSC1 may be arranged to provide an oscillating voltage signal v_{OSC}(t), which has a substantially constant amplitude. The voltage meter M1 may be arranged to monitor the voltage v₀(t). The voltage signal v_{OSC}(t) may be coupled to the inductor L0 via a resistor Z₂₀₀ so that the voltage difference over the resistor Z₂₀₀ may be substantially proportional to the current i₀(t). Consequently, an increase of the current i₀(t) may cause a reduction of the voltage v₀(t). The frequency f of the voltage signal v_{OSC}(t) may be varied, and a gain response curve R(f) may be determined e.g. by measuring the amplitude of the voltage v₀(t) as the function of the frequency f, and by comparing voltage v₀(t) of the inductor L0 with the voltage v_{OSC}(t).

The voltage v_{OSC}(t) may refer to the voltage between nodes T0C and T0B. The voltage v₀(t) may refer to the voltage between nodes T0A and T0C. The resistor Z₂₀₀ may be connected between the nodes T0C and T0A.

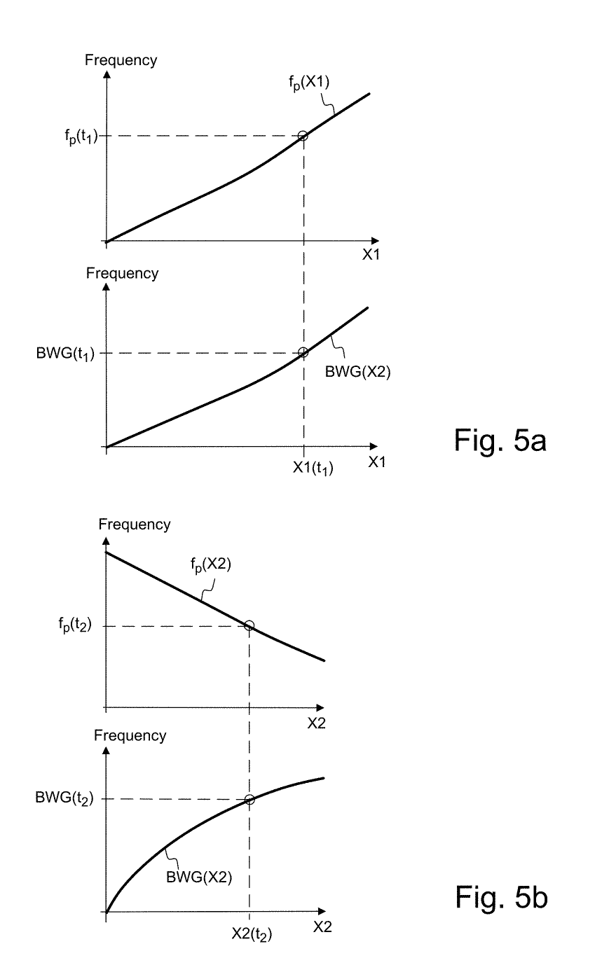

Referring to FIGS. 4a and 4b, the method may comprise measuring the spectral position fₚ of a resonance peak of the resonance circuit CIR1. The method may comprise providing a gain response function R(f) which has a local minimum at the resonance frequency fₚ of the resonance circuit CIR1.

The gain response function R(f) may be represented as a gain response curve. The apparatus 500 may be arranged to identify one or more features of the gain response R(f). For example, the apparatus 500 may be arranged to detect a resonance portion of the gain response curve. In particular, the apparatus 500 may be arranged to detect a resonance dip RDIP of the gain response curve R(f), see FIGS. 4a and 4b. The apparatus 500 may be arranged to determine one or more characteristic values from the features of the gain response curve R(f). For example, the apparatus 500 may be arranged to determine a resonance frequency fₚ by determining a frequency where the gain response R(f) has a local minimum. For example, the apparatus 500 may be arranged to determine a spectral width BWG by analyzing the gain response curve R(f) in the vicinity of the resonance frequency fₚ.

FIG. 4a shows a gain response curve R(f) associated with a first composition of a heterogeneous mixture MX, and FIG. 4b shows a gain response curve R(f) associated with a second different composition of a heterogeneous mixture MX. FIG. 4a may be associated with a first state of the heterogeneous mixture MX, and FIG. 4b may be associated with a second state of the heterogeneous mixture MX. The gain response curves R(f) may be measured e.g. by using the set-up shown in FIG. 3b.

The gain response R(f) may have a local minimum at the resonance frequency fₚ of the resonance circuit CIR1. The gain response curve R(f) may have a resonance dip RDIP at the resonance frequency fₚ of the resonance circuit CIR1. The gain response R(f) may have a minimum value R_{MIN} and a maximum value R_{MAX}. ΔR denotes the difference R_{MAX}−R_{MIN}, i.e. the depth of the resonance dip RDIP. The resonance dip RDIP may have a spectral width BWG, which may mean e.g. the difference between the frequencies where the gain response R(f) is reduced by 3 dB when compared with the maximum value R_{MAX}.

A change of the composition of the heterogeneous mixture MX may cause e.g. a change of the resonance frequency fₚ and/or may cause e.g. a change of the spectral width BWG. The resonance frequency fₚ and/or the spectral width BWG may be determined by analyzing the driving signal S0. A change of the resonance frequency fₚ and/or a change of the spectral width BWG may be determined by analyzing the driving signal S0.

The method may comprise determining a relation between a change of a measurand and a change of a characteristic feature of the gain response R(f).

The heterogeneous mixture MX may have a first state at a first time (e.g. t₁) and a second state at a second time (e.g. t₂). For example, the concentration of particles P1 at a time t₁ may be different from the concentration of particles P1 at a time t₂. The method may comprise measuring a first gain response when the heterogeneous mixture MX is in the first state, measuring a second gain response when the heterogeneous mixture MX is in the second different state. The change of the concentration may be detected by comparing the second gain response with the first gain response. The change of a concentration of a substance in the heterogeneous mixture MX may alter the gain response, and the change of the concentration may be determined by measuring the change of the gain response when compared with the initial situation.

The method may comprise measuring a gain response R(f) as a function of frequency f, and determining a spectral position fₚ of a feature of the gain response R(f).

The method may comprise measuring a gain response R(f) as a function of frequency f, and determining a spectral width BWG of a feature of the gain response R(f).

The method may comprise measuring the impedance Z₁₀₀(f) of the coupled reader coil L0 as a function of frequency f, and determining the resonance frequency fₚ and/or the spectral width BWG from the impedance Z₁₀₀(f) of the coupled reader coil L0. The method may comprise measuring the impedance Z_{SEN}(f) of the coupled sensor coil L1 as a function of frequency f, and determining the resonance frequency fₚ and/or the spectral width BWG from the impedance Z_{SEN}(f) of the coupled sensor coil L1. The method may comprise determining at least one property X1, X2 from the measured spectral position fₚ and/or from the measured spectral width BWG.

A spectral feature of the impedance Z₁₀₀ or Z_{SEN} may be described e.g. by fitting a polynomial function to the spectral feature. A characteristic portion of a gain response R(f) may be described e.g. by fitting a polynomial function to the characteristic portion. The method may comprise performing polynomial fitting to a measured gain response curve R(f) so as to determine one or more numerical values associated with a characteristic portion of the gain response curve. The measured gain response curve may have a dip RDIP on the frequency axis (FIGS. 4a and 4b). The dip RDIP may be characterized e.g. by two features: the resonance frequency fₚ and the bandwidth (BWG) of the dip. These features may be extracted e.g. by fitting a polynomial model on the measured gain response. The method may optionally comprise measuring a baseline gain response in a situation where the reader coil L0 is not coupled to the resonance circuit CIR1. The baseline of the decoupled reader coil may be optionally subtracted from the measured gain response R(f) in order to provide a compensated gain response. A polynomial function may be subsequently fitted to the measured gain response curve or to the compensated gain response curve. The polynomial function may be e.g. a 3rd order polynomial. The 3rd order polynomial may provide a relatively robust and generalized model to describe the peaks and dips of frequency response data. The 3rd order polynomial may also take into account possible asymmetry of the resonance dip RDIP. The resonance frequency fₚ may be determined to be a frequency where the fitted (polynomial) function attains its minimum value. The spectral width BWG may be determined by using the fitted (polynomial) function. The gain response R(f) may have a maximum value R_{MAX}, and the resonance dip RDIP may have a depth ΔR. The spectral width BWG may be the spectral difference between the two points where the fitted (polynomial) function is equal to RMAX−ΔR/√2. The spectral width BWG may be the spectral difference which corresponds to −3 dB bandwidth. The resonance frequency fₚ may depend on the relative permittivity of the sample volume of the heterogeneous mixture MX. The spectral width BWG may depend on the losses in the resonator and the dielectric losses in the sample volume of the heterogeneous mixture MX.

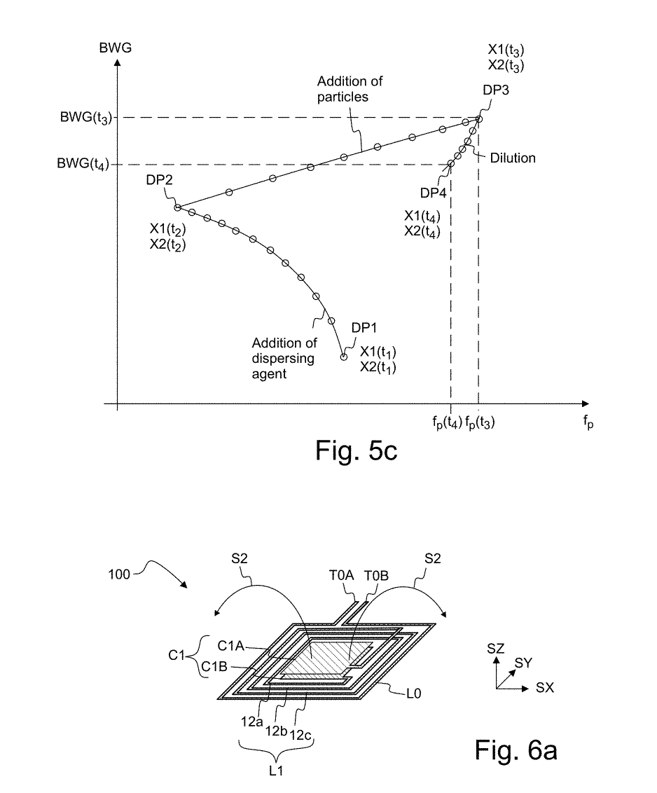

Referring to FIG. 5a, the resonance frequency fₚ and/or the spectral width BWG of a spectral feature may depend on a first property X1 of the heterogeneous mixture MX. For example, the first property X1 may have a value X1(t₁) at a time t₁ such that the value X1(t₁) corresponds to a resonance frequency fₚ(t₁) and a spectral width BWG(t₁). The first property X1 may be e.g. the mass fraction of particles P1 contained in the heterogeneous mixture MX. Consequently, the first property X1 may be determined from the resonance frequency fₚ and/or from the spectral width BWG.

The dielectric constant (i.e. real part of the permittivity) of the particles P1 may be lower than the dielectric constant of the liquid component of the heterogeneous mixture MX. For example, the heterogeneous mixture may contain plastic or ceramic particles P1 suspended in water. Thus, an increase of the volume fraction of the particles P1 may reduce an effective dielectric constant of the heterogeneous mixture MX, thereby reducing the capacitance of the capacitor C1 and increasing the resonance frequency fₚ.

The dielectric constant (i.e. real part of the permittivity) of the particles P1 may be higher than the dielectric constant of the liquid component of the heterogeneous mixture MX. For example, the heterogeneous mixture MX may contain water droplets suspended in oil. Thus, an increase of the volume fraction of the particles P1 may increase an effective dielectric constant of the heterogeneous mixture MX, thereby increasing the capacitance of the capacitor C1 and decreasing the resonance frequency fₚ.

The heterogeneous mixture MX may be e.g. slurry, which comprises aluminum oxide (Al₂O₃) particles P1 suspended in water. The heterogeneous mixture MX may be an aluminum oxide slurry. The first property X1 may be e.g. the volume fraction of the aluminum oxide particles P1. The relationship between the resonance frequency fₚ and the volume fraction X1 of the aluminum oxide particles P1 may be substantially linear. The average slope (Δfₚ/ΔX1) of the relationship may be e.g. approximately equal to 18 kHZ/vol %. Thus, a change ΔX1 of the volume fraction X1 of the aluminum oxide particles P1 may be determined from a change Δfₚ of the resonance frequency fₚ. A change ΔX1 of the volume fraction X1 of the aluminum oxide particles P1 may be determined from a change Δfₚ of the resonance frequency fₚ in a situation where the concentrations of additives (e.g. the concentration of a dispersing agent) remain constant.

Referring to FIG. 5b, the resonance frequency fₚ and/or the spectral width BWG of a spectral feature may depend on a second property X2 of the heterogeneous mixture MX. For example, the second property X2 may have a value X2(t₂) at a time t₂ such that the value X2(t₂) corresponds to a resonance frequency fₚ(t₂) and a spectral width BWG(t₂). Consequently, the second property X2 may be determined from the resonance frequency fₚ and/or from the spectral width BWG. The second property X2 may be e.g. the mass fraction of a dispersing agent in the heterogeneous mixture MX.

A change ΔX2 of the concentration X2 of the dispersing agent may cause a change Δfₚ of the resonance frequency fₚ. The relationship between the change ΔX2 of the concentration X2 and the change Δfₚ of the resonance frequency fₚ may be substantially linear. The slope Δfₚ/ΔX2 may be e.g. substantially equal to −35 kHz/(g/l).

A change ΔX2 of the concentration X2 of the dispersing agent may cause a change ΔBWG of the spectral width BWG. The relationship between the change ΔX2 of the concentration X2 and the change ΔBWG may be nonlinear.

The dispersing agent may have long polarized molecules, which may be attached to the surfaces of the particles P1. Interaction of the long polarized molecules with the surfaces of the particles P1 in the oscillating electric field S2 may absorb energy. The changes of the measured features (e.g. change of resonance frequency fₚ, change of spectral width BWG) may be at least partly caused by local charging of molecules on the surface of the particles P1 and/or by local charging of molecules on the surface of the particles P1. Increasing the mass fraction of the dispersing agent may increase losses in the vicinity of the capacitive electrode C1a, thereby increasing the spectral width of the resonance dip (or the spectral width of a resonance peak). The origin of the found changes in the measured values may be caused by charging of molecules and surfaces and their interaction. Monitoring the input impedance Z_{SEN} of the sensor module SEN1 may provide information about the state of the (liquid-solid) interface between the liquid phase LIQ1 and the particles P1 of the heterogeneous mixture MX.

Referring to FIG. 5c, the heterogeneous mixture MX may have a first property X1 and a second property X2. The first property may have a value X1(t₁) at a time t₁. The second property X2 may have a value X2(t₁) at the time t₁. The first property may have a value X1(t₂) at a time t₂. The second property X2 may have a value X2(t₂) at the time t₂. The first property may have a value X1(t₃) at a time t₃. The second property X2 may have a value X2(t₃) at the time t₃. The first property may have a value X1(t₄) at a time t₄. The second property X2 may have a value X2(t₄) at the time t₄. Each pair of property values X1, X2 may correspond to a combination of a resonance frequency fₚ and a spectral width BWG. Each pair of property values X1, X2 may correspond to a pair of values fₚ and BWG. For example, the values X1(t₃) and X2(t₃) may correspond to the values fₚ(t₃) and BWG(t₃), and the values X1(t₄) and X2(t₄) may correspond to the values fₚ(t₄) and BWG(t₄).

Preparation of a heterogeneous mixture MX may correspond to a curve on a two-dimensional space defined by the measureable variables fₚ and BWG. Each point (fₚ, BWG) may correspond to a pair of values X1, X2. The values X1, X2 may be determined from the measured values fₚ, BWG e.g. by using calibration data PARA1.

The relationship between the properties of the heterogeneous mixture and the complex impedance spectrum of the sensor module may be determined e.g. by calibration measurements or by simulation. The relationship may be expressed e.g. by using a regression function. The calibration data PARA1 may comprise e.g. parameters of the regression function.

The first property X1 may be e.g. the mass fraction of particles P1. The second property X2 may be e.g. the mass fraction of a dispersing agent.

Preparation of a heterogeneous mixture may comprise e.g. mixing a first substance with a second substance, adding a second substance to a first substance and/or removing a second substance from a first substance. Preparation of a heterogeneous mixture may comprise e.g.

adding a liquid substance to the heterogeneous mixture, removing a liquid substance from the heterogeneous mixture, adding particles to the heterogeneous mixture and/or removing particles from the heterogeneous mixture (e.g. by filtering). Preparation of a heterogeneous mixture may comprise causing a reaction, which in turn causes formation of a substance in the heterogeneous mixture. Preparation of a heterogeneous mixture may comprise causing a reaction, which in turn causes formation of particles in the heterogeneous mixture. Preparation of a heterogeneous mixture may comprise causing a reaction, which in turn removes particles from the heterogeneous mixture.

For example, a first preparation step may comprise adding a dispersing agent to the heterogeneous mixture MX. The measured values fₚ, BWG may evolve from a data point DP1 to a data point DP2 along the curve which joins said data points DP1, DP2. For example, a second preparation step may comprise adding particles P1 to the heterogeneous mixture MX. The measured values fₚ, BWG may evolve from a data point DP2 to a data point DP3 along the curve which joins said data points DP2, DP3. For example, a third preparation step may comprise diluting the heterogeneous mixture MX. The measured values fₚ, BWG may evolve from a data point DP3 to a data point DP4 along the curve which joins said data points DP3, DP4. The first preparation step, the second preparation step and/or the third preparation step may be optional. The preparation steps may also be performed in a different order. For example, the preparation may start with the addition of particles. For example, the preparation may start with dilution. For example, the dilution step may be omitted.

The mass fraction of particles P1 and/or the mass fraction of the dispersing agent may be measured by measuring the resonance frequency fₚ and the spectral width BWG. The mass fraction of the particles and/or the mass fraction of the dispersing agent may be determined from the measured parameters (Fₚ, BWG) e.g. by using calibration parameters PARA1. The calibration parameters PARA1 may be determined e.g. experimentally or by computer simulation.

The sensor module SEN1 may be located e.g. on the bottom of a container DUC1 during preparation of the heterogeneous mixture MX.

The method may comprise controlling preparation of the heterogeneous mixture MX based on one or more property values X1, X2 determined by monitoring the impedance of the resonance circuit CIR1.

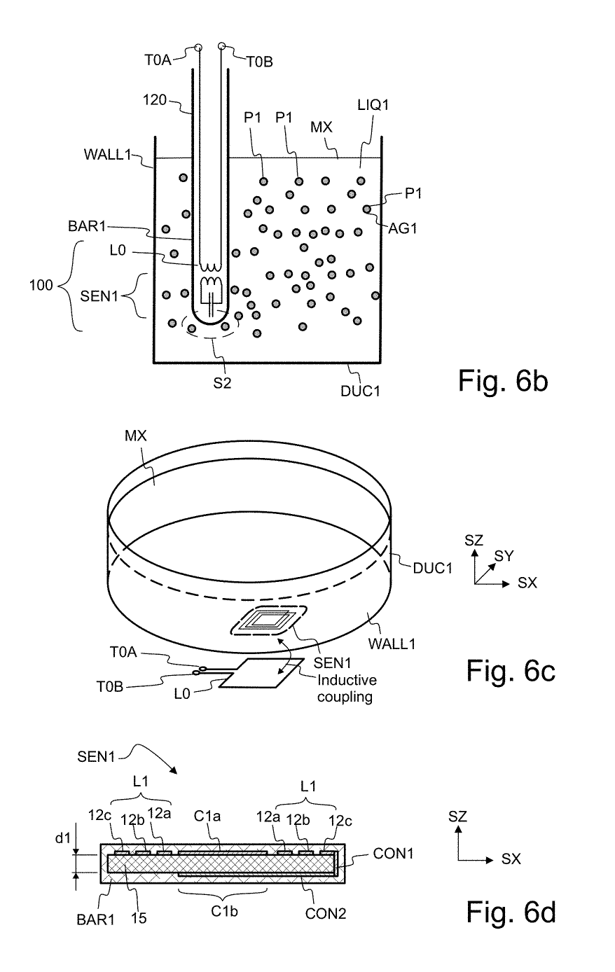

FIG. 6a shows, by way of example, the structure of the electrically conductive parts of the sensor unit 100. The sensor unit 100 may comprise the resonance circuit CIR1. The resonance circuit CIR1 may comprise the capacitor C1 and the inductor L1 connected in parallel. The capacitor C1 may comprise capacitive elements C1a, C1b. At least one of the capacitive elements C1a, C1b may operate as the capacitive electrode of the sensor unit 100. At least one of the elements C1a, C1b may generate the oscillating electric field S2 during operation of the sensor unit 100. The elements C1a, C1b may be e.g. capacitive plates. The elements C1a, C1b may be e.g. substantially planar plates. The elements C1a, C1b may together form a parallel plate capacitor C1.

The inductor L1 may comprise one or more turns 12a, 12b, 12c. The sensor unit 100 may optionally comprise the reader coil L0. The reader coil L0 may have terminals T0a, T0B for coupling the driving signal S0 to the reader coil L0. The reader coil L0 may comprise e.g. one or more turns of a conductor.

The coil L1 and the capacitive electrodes C1a, C1b may be implemented on a substrate, e.g. on a plastic foil. The coil L1 and the capacitive electrodes C1a, C1b may be formed from a metal foil e.g. by etching, by laser cutting. The coil L1 and the capacitive electrodes C1a, C1b may be formed e.g. by applying electrically conductive material on the substrate.

The sensor module SEN1 or the sensor unit 100 may be encapsulated in an electrically insulating material, i.e. in a dielectric material. The sensor module SEN1 or the sensor unit 100 may be covered with a dielectric material. The sensor module SEN1 or the sensor unit 100 may be installed e.g. into an end of a probe. The sensor module SEN1 may be simple and robust. The sensor module SEN1 may suitable for use in an industrial environment. The sensor module SEN1 may be positioned e.g.

close to a moving mixer blade. The sensor module SEN1 may be positioned e.g. close to a rotating impeller.

SX, SY and SZ may denote orthogonal directions of a coordinate system.

Referring to FIG. 6b, the sensor module SEN1 or the sensor unit 100 may be positioned e.g. in a measurement probe 120. The measurement probe 120 may be at least partly immersed in the heterogeneous mixture MX. An end of the measurement probe may be immersed in the heterogeneous mixture MX. The measurement probe may have e.g. a cylindrical form such that an end of the probe may be easily positioned inside a duct or container through an opening of a wall of the duct or container. The method may comprise using a measurement probe, which may comprise a resonance circuit, a sensor coil, a sensor antenna, a reader coil, and a dielectric barrier. The sensor coil may operate as an inductive part of the resonance circuit, and the sensor antenna may operate as a capacitive part of the resonance circuit. An oscillating voltage coupled to the reader coil may induce oscillating voltage in the resonance circuit so that the sensor antenna may generate an oscillating electric field in the heterogeneous mixture. The dielectric barrier may be positioned between the sensor antenna and the heterogeneous mixture in order to control and/or reduce losses caused by the heterogeneous mixture.

Referring to FIG. 6c, the sensor module SEN1 or the sensor unit 100 may be positioned e.g. on the inner surface of a container or duct DUC1. The reader coil L0 may be coupled to the sensor module SEN1 through a wall WALL1 of the container or duct DUC1. The sensor module SEN1 may be thin such that the sensor module SEN1 does not significantly disturb flow pattern inside the container or duct DUC1. The sensor module SEN1 may be attached to the inner surface of the wall WALL1 such that the sensor module SEN1 does not significantly protrude from the inner surface. The sensor module SEN1 may be thin such that the sensor module SEN1 does not significantly disturb e.g. operation of a mechanical stirring element. The electrically conductive parts L1, C1a, C1b of the sensor module SEN1 may be encapsulated in a dielectric material BAR1.

FIG. 6d, shows, by way of example, a cross-sectional view of the sensor module SEN1. The sensor module SEN1 may comprise a first capacitive element C1a and a second capacitive element C1b separated by a dielectric layer 15. The first capacitive element C1a may be connected to the inductor L1, which may comprise one or more turns 12a, 12b, 12c. The inductor L1 may be connected to the second capacitive element C1b e.g. by one or more conductive parts CON1, CON2. The conductive parts of the sensor module SEN1 may be encapsulated in the dielectric material BAR1. The elements C1a, C1b may be attached to the insulating layer 15 such that a change of pressure of the mixture MX does not cause a significant change of distance d1 between the elements C1a, C1b.

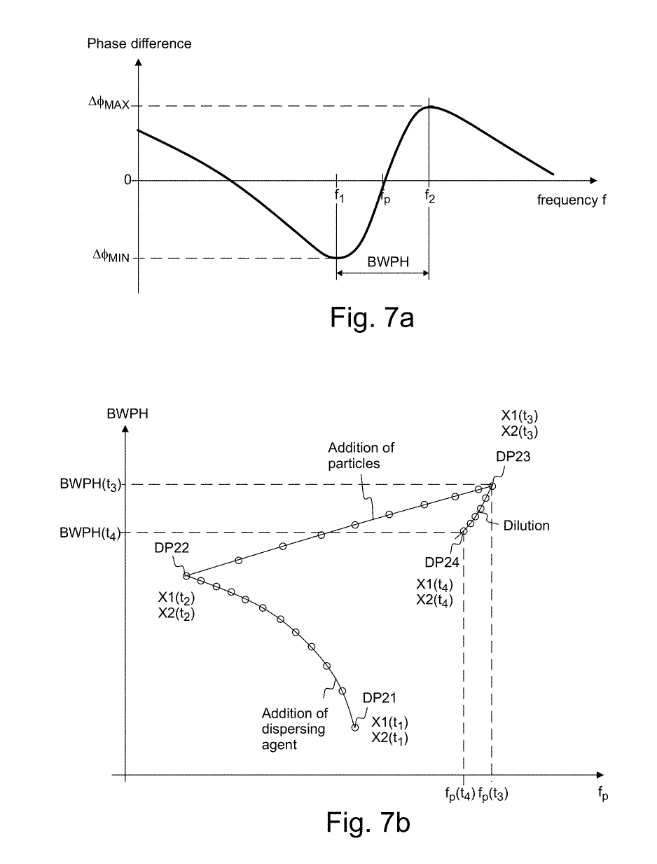

FIG. 7a shows, by way of example, the phase difference Δφ between current i₀(t) and voltage v₀(t) waveforms of the reader coil L0. The phase difference Δφ may be substantially equal to zero at the resonance frequency fₚ. The phase difference Δφ may have a local minimum Δφ_{MIN} at a frequency f₁. The phase difference Δφ may have a local maximum Δφ_{MAX} at a frequency f₂. The difference f₂−f₁ may be called e.g. as the spectral width BWPH. The spectral width BWPH may denote the spectral separation f₂−f₁ between the frequencies f₁, f₂ associated with the minimum phase difference Δφ_{MIN} and the maximum phase difference Δφ_{MAX}. The method may comprise determining a spectral width BWPH from the measured phase shift φ(t). The method may comprise determining a property X1, X2 of the heterogeneous mixture MX from the spectral width BWPH. The method may comprise determining a property X1, X2 of the heterogeneous mixture MX from the resonance frequency fₚ and/or from the spectral width BWPH e.g. by using calibration data PARA1.

The resonance frequency fₚ and/or the spectral width BWPH of a spectral feature may depend on a first property X1 of the heterogeneous mixture MX. For example, the first property X1 may have a value X1(t₁) at a time t₁ such that the value X1(t₁) corresponds to a resonance frequency fₚ(t₁) and a spectral width BWPH(t₁). The first property X1 may be e.g. the mass fraction of particles P1 contained in the heterogeneous mixture MX. Consequently, the first property X1 may be determined from the resonance frequency fₚ and/or from the spectral width BWPH.

Referring to FIG. 7b, the heterogeneous mixture MX may have a first property X1 and a second property X2. The first property may have a value X1(t₁) at a time t₁. The second property X2 may have a value X2(t₁) at the time t₁. The first property may have a value X1(t₂) at a time t₂. The second property X2 may have a value X2(t₂) at the time t₂. The first property may have a value X1(t₃) at a time t₃. The second property X2 may have a value X2(t₃) at the time t₃. The first property may have a value X1(t₄) at a time t₄. The second property X2 may have a value X2(t₄) at the time t₄. Each pair of property values X1, X2 may correspond to a combination of a resonance frequency fₚ and a spectral width BWPH. Each pair of property values X1, X2 may correspond to a pair of values fₚ and BWPH. For example, the values X1(t₃) and X2(t₃) may correspond to the values fₚ(t₃) and BWPH(t₃), and the values X1(t₄) and X2(t₄) may correspond to the values fₚ(t₄) and BWPH(t₄).

Preparation of a heterogeneous mixture MX may correspond to a curve on a two-dimensional space defined by the measureable variables fₚ and BWPH. Each point (fₚ, BWPH) may correspond to a pair of values Xl, X2. The values X1, X2 may be determined from the measured values fₚ, BWPH e.g. by using calibration data PARA1.

The first property X1 may be e.g. the mass fraction of particles P1. The second property X2 may be e.g. the mass fraction of a dispersing agent. For example, a first preparation step may comprise adding a dispersing agent to the heterogeneous mixture MX. The measured values fₚ, BWPH may evolve from a data point DP21 to a data point DP22 along the curve which joins said data points DP21, DP22. For example, a second preparation step may comprise adding particles P1 to the heterogeneous mixture MX. The measured values fₚ, BWPH may evolve from a data point DP22 to a data point DP23 along the curve which joins said data points DP22, DP23. For example, a third preparation step may comprise diluting the heterogeneous mixture MX. The measured values fₚ, BWPH may evolve from a data point DP23 to a data point DP24 along the curve, which joins said data points DP23, DP24.

The method may provide data indicative of relative electrical permittivity of a heterogeneous mixture. The method may provide data indicative of a change of the permittivity. The method may provide data indicative of a difference between a first permittivity at a first position and a second permittivity at a second different position. The method may provide data indicative of a difference between a first permittivity at a first time and a second permittivity at a second different time. The method may provide data indicative of a ratio of the first permittivity to the second permittivity.

The method may comprise monitoring homogeneity of a heterogeneous mixture MX guided through a duct DUC1. The method may comprise monitoring homogeneity of a heterogeneous mixture MX, which is agitated in a container DUC1. The method may comprise moving the heterogeneous mixture MX and determining the degree of homogeneity of the heterogeneous mixture MX from the detected variation of the resonance frequency fₚ(t).

The method may comprise monitoring spatial distribution X1(x,y,z) of a property X1 of the heterogeneous mixture MX. The method may comprise monitoring temporal evolution X1(x,y,z,t) of the property X1 at a given position (x,y,z). The heterogeneous mixture may move with respect to the container or duct DUC1. The heterogeneous mixture MX may move in a duct or container DUC1. The heterogeneous mixture MX may be agitated in a container DUC1. x, y, and z may denote position coordinates of a point which is stationary with respect to the container or duct DUC1. The spatial distribution X1(x,y,z) may be determined e.g. from temporal variation Z_{SEN}(f,t) of the impedance of the sensor module. The spatial distribution X1(x,y,z) may be determined e.g. from temporal variation of the resonance frequency fₚ(t) and/or from temporal variation of the spectral width BWG(t) or BWPH(t). The method may comprise monitoring temporal evolution X1(x,y,z,t) of a property X1 of the heterogeneous mixture MX at least one position (x,y,z). The method may comprise monitoring spatial distribution X1(x,y,z) of a concentration X1 of a substance P1, AG1 in the heterogeneous mixture MX. The method may comprise monitoring temporal evolution X1(x,y,z,t) of a concentration X1 of a substance P1, AG1 in the heterogeneous mixture MX.

Small spatial variation of the particle density may e.g. improve the efficiency of a subsequent manufacturing process, which is based on the use of the heterogeneous mixture MX.

The method may comprise monitoring settling of particles P1 in the liquid LIQ1. The method may comprise monitoring sedimentation of a heterogeneous mixture MX. The density of the particles P1 may be higher than the density of the liquid medium of the heterogeneous mixture MX. The volume fraction of particles P1 may decrease in an upper part of a container DUC1 and increase in a lower part of the container DUC1 due to gravity.

The method may comprise monitoring flotation of particles P1 in the liquid LIQ1. The density of the particles P1 may also be lower than the density of the liquid medium of the heterogeneous mixture MX. The volume fraction of particles P1 may increase in an upper part of a container DUC1 and decrease in a lower part of the container DUC1 due to gravity. The method may comprise monitoring flotation in a heterogeneous mixture MX.

Spatial variation of particle density may also be caused e.g. due to a centrifugal effect.

The method may comprise detecting a change of particle concentration. The method may comprise detecting a change of concentration of a dispersing agent.

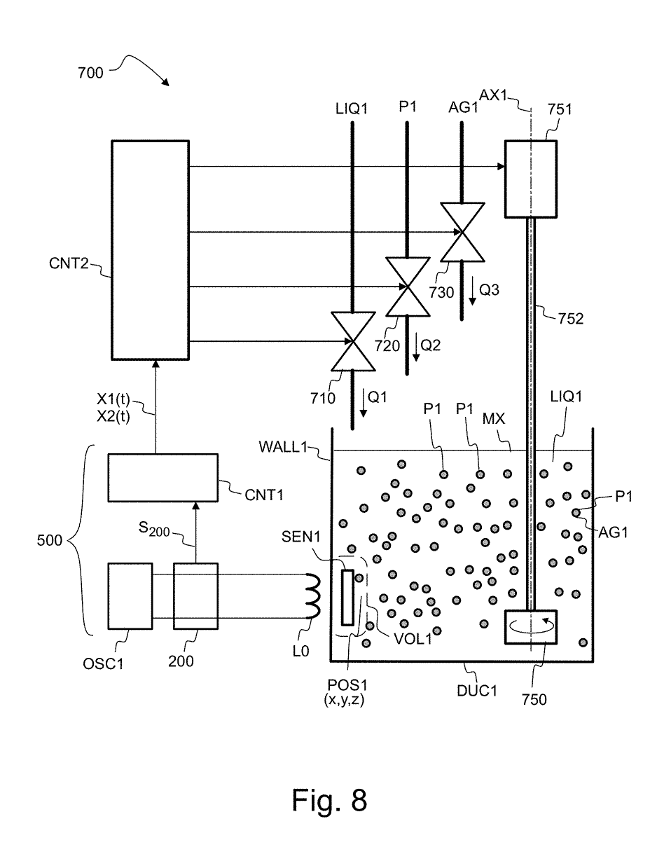

Referring to FIG. 8, a heterogeneous mixture MX may be produced e.g. by using an apparatus 700. The apparatus 700 for preparing the heterogeneous mixture MX may comprise the measuring apparatus 500, a control unit CNT2, and one or more control devices 710, 720, 730. A first control device 710 may e.g. control the flow rate Q1 or an amount of a liquid medium LIQ1 added to the mixture MX. A second control device 720 may e.g. control the flow rate Q2 or an amount of a particles P1 added to the mixture MX. A third control device 730 may e.g. control the flow rate Q3 or an amount of a substance AG1 added to the mixture MX. The apparatus 700 may be arranged to guide the substance (LIQ1, P1, AG1) from the control device 710, 720, 730 into a duct or container DUC1, which contains the mixture MX. The sensor module SEN1 of the measuring apparatus 500 may be arranged to monitor at least one property X1, X2 of the mixture MX contained in said duct or container DUC1. For example, the flow of liquid LIQ1 may be increased and/or the flow of particles P1 may be decreased in a situation where the measured particle concentration X1 is lower than a reference value.

The control unit CNT2 may control operation of the devices 710, 720, 730 based on the measurement result X1, X2 provided by the measuring apparatus 500. The control devices 710, 720, 730 may control the flow of the substances LIQ1, P1, AG1 introduced into a vessel or duct DUC1. The device 710, 720, 730 may comprise e.g. a valve, and/or a pump. The measuring apparatus 500 may comprise the sensor module SEN1, a reader coil L0, a monitoring unit 200, and oscillator OSC1, and a data processing unit CNT1.

The production apparatus 700 may comprise:
the measuring apparatus 500,
a control unit CNT2, and
one or more control devices 710, 720, 730,

wherein at least one of said control devices 710, 720, 730 may be arranged to control the flow rate of a substance (LIQ1, P1, AG1) or an amount of a substance based on data provided by the measuring apparatus 500.

The sensor module SEN1 may be arranged to monitor a portion of the mixture MX which is located within a sample volume VOL1 in the vicinity of the sensor module SEN1. The sample volume VOL1 may have a position POS1, which may be specified e.g. by coordinates x,y,z. The sensor module SEN1 may be substantially insensitive to changes of particle concentration which take place outside the sample volume VOL1.

The apparatus 700 may optionally comprise a mixing element 750. The mixing element 750 may be moved by an actuator 751. The mixing element 750 may be e.g. a paddle, which is rotated about an axis AX1 by using a motor 751 and a shaft 752. The apparatus 700 may be arranged to control operation of the mixing element 750 based on the measurement data S₂₀₀ provided by the measuring apparatus 500. The apparatus 700 may be arranged to control operation of the mixing element 750 based on information about the spatial variation of particles P1 in the mixture MX. The apparatus 700 may be arranged to control flow rate of a dispersing agent based on information about the spatial variation of particles P1 in the mixture MX.

A method for producing a heterogeneous mixture MX may comprise:
obtaining a heterogeneous mixture (MX), which comprises particles (P1) suspended in a liquid medium (LIQ1),
coupling an oscillating radio frequency electric field S2 to the heterogeneous mixture MX by using at least one capacitive electrode C1a,
determining at least one measured property X1 of the heterogeneous mixture MX by monitoring an input impedance of a sensor module SEN1, which comprises said at least one capacitive electrode C1a, and
controlling the volume fraction of the particles P1 based on the at least one measured property X1.

The method may comprise controlling preparation of a heterogeneous mixture. The volume fraction of the particles P1 may be controlled e.g. by adding more liquid LIQ1 to the heterogeneous mixture MX, evaporating liquid away from the heterogeneous mixture, and/or by adding more particles P1 to the heterogeneous mixture. The method may further comprise adding an additive AG1 to the heterogeneous mixture. The method may further comprise controlling concentration of the additive AG1.

The method may comprise checking whether a measured property X1, X2 of the heterogeneous mixture MX is in a predetermined range. The method may comprise controlling the concentration of a substance X1, X2 based on the complex permittivity of the heterogeneous mixture MX. The method may comprise controlling the concentration X1, X2 of a substance by monitoring the impedance of the device 100. The monitoring signal S₂₀₀ may be used as a feedback signal for controlling at least one property X1, X2 of the heterogeneous mixture MX.

The method may comprise monitoring the quality of a heterogeneous mixture MX by monitoring the impedance of the sensor module SEN1. The method may comprise classifying heterogeneous mixtures MX into two or more groups by monitoring the impedance of the sensor module SEN1.

The heterogeneous mixture MX may be used e.g. for manufacturing a ceramic component, a paint, a coating, a cosmetic product, a building element, a medicament, or a catalyzing substance. The heterogeneous mixture MX may be e.g. a mineral slurry, which may be related to mining and/or mineral enrichment. A method for manufacturing a ceramic component may comprise e.g. spray drying and/or slip casting by using a heterogeneous mixture, which comprises fine ceramic particles P1 suspended in a liquid LIQ1.

The dispersing agent may use e.g. an ionic repulsion mechanism to disperse inorganic particles P1. The inorganic particles P1 may comprise e.g. aluminum oxide, calcium carbonate, titanium dioxide and/or talc. The heterogeneous mixture MX may be e.g. a waterborne paint, a waterborne coating material, a waterborne adhesive, or a construction material. The dispersing agent may be e.g. a polyacrylic dispersant. The dispersing agent may comprise pure polyacrylic acid (PAA) or polyacrylic acid modified with alkylacrylates. The use of the dispersing agent may e.g. reduce viscosity of the heterogeneous mixture MX. The use of the dispersing agent may allow increasing the volume fraction of the particles P1. The use of the dispersing agent may allow higher opacity of a paint or coating. The use of the dispersing agent may e.g. improve gloss of a paint or coating. The use of the dispersing agent may e.g. improve water-resistance (hydrophobicity).

The term heterogeneous mixture may mean solid or liquid particles P1 suspended in a liquid LIQ1. The particles P1 of the heterogeneous mixture MX may have substantially similar chemical composition or the heterogeneous mixture MX may comprise several different types of particles P1. For example, the heterogeneous mixture MX may comprise first particles P1 which have a first composition, and the heterogeneous mixture MX may comprise second particles which have a second different composition. The size of the first particles P1 may be substantially equal to the size of the second particles P2, or the first particles P1 may be substantially larger than the second particles P2. The heterogeneous mixture MX may optionally comprise one or more additional substances AG1. For example, the heterogeneous mixture MX may comprise a dispersing agent AG1.

For the person skilled in the art, it will be clear that modifications and variations of the devices and the methods according to the present invention are perceivable. The figures are schematic. The particular embodiments described above with reference to the accompanying drawings are illustrative only and not meant to limit the scope of the invention, which is defined by the appended claims.

What is claimed is:

1. A method for monitoring at least one property of a heterogeneous mixture, the method comprising:
coupling an oscillating radio frequency electric field to the heterogeneous mixture by using at least one capacitive electrode, and
determining at least one property of the heterogeneous mixture by monitoring an input impedance of a sensor module, which comprises said at least one capacitive electrode.

2. The method of claim 1 wherein the sensor module comprises a resonance circuit, the resonance circuit is an inductor capacitor resonance circuit, and the capacitive electrode operates as a part of the resonance circuit.

3. The method of claim 2 wherein the resonance circuit comprises a first inductor, a second inductor is inductively coupled to the first inductor, and the method comprises applying a driving signal to the second inductor so as to cause oscillation of the resonance circuit.

4. The method of claim 3, comprising monitoring an input impedance of the second inductor, which is inductively coupled to the first inductor of the resonance circuit.

5. The method of claim 2, comprising varying a frequency of a driving signal, which is coupled to the resonance circuit.

6. The method of claim 2, comprising measuring the spectral position of a resonance peak of the resonance circuit.

7. The method of claim 6, comprising determining at least one property of the heterogeneous mixture from the measured spectral position.

8. The method of claim 2, comprising measuring a spectral width of a resonance peak of the resonance circuit.

9. The method of claim 8, comprising determining at least one property of the heterogeneous mixture from the measured spectral width.

10. The method of claim 2, comprising measuring the spectral position of a resonance peak of the resonance circuit, measuring a spectral width of a resonance peak of the resonance circuit, determining a first property of the heterogeneous mixture from the measured spectral position, and determining a second property of the heterogeneous mixture from the measured spectral width.

11. The method of claim 10 comprising determining concentration of particles and concentration of a dispersing agent from the measured spectral position and from the measure spectral width.

12. The method of claim 1 wherein the capacitive electrode is separated from the heterogeneous mixture by a barrier layer.

13. An apparatus, comprising:
at least one capacitive electrode to couple an oscillating radio frequency electric field to a heterogeneous mixture,
a resonance circuit, which comprises said at least one capacitive electrode, and
a data processing unit configured to determine at least one property of the heterogeneous mixture by monitoring an input impedance of the resonance circuit.

14. The apparatus of claim 13, wherein the resonance circuit comprises an inductor and a capacitor, wherein the capacitor comprises said at least one capacitive electrode.

15. The apparatus of claim 14, further comprising a signal generator coupled to a reader coil, the reader coil is inductively coupled to the inductor of the resonance circuit, and wherein the signal generator and the reader coil are arranged to cause oscillation of the resonance circuit.

16. The apparatus of claim 15, wherein the frequency of an oscillator signal generated by the signal generator is variable.

17. The apparatus of claim 15, comprising a monitoring unit to monitor the voltage of the reader coil.

18. The apparatus of claim 13 comprising a dielectric barrier, which covers the at least one capacitive electrode of the sensor module.

19. A method for producing a heterogeneous mixture, the method comprising:
obtaining a heterogeneous mixture, which comprises particles suspended in a liquid medium,
coupling an oscillating radio frequency electric field to the heterogeneous mixture by using at least one capacitive electrode,
determining at least one measured property of the heterogeneous mixture by monitoring an input impedance of a sensor module, which comprises said at least one capacitive electrode, and
controlling at least one property of the heterogeneous mixture based on the at least one measured property.

20. The method of claim 19 comprising changing the volume fraction of particles in the heterogeneous mixture based on the at least one measured property.
